(19) United States
(12) Patent Application Publication
(10) Pub. No.: US 2014/0229644 A1
(43) Pub. Date: Aug. 14, 2014

(54) METHOD, APPARATUS, SYSTEM FOR INCLUDING INTERRUPT FUNCTIONALITY IN SENSOR INTERCONNECTS

(71) Applicants: Haran Thanigasalam, San Jose, CA (US); Kenneth Foust, Beaverton, OR (US); Rajasekaran Andiappan, Tampere (FI)

(72) Inventors: Haran Thanigasalam, San Jose, CA (US); Kenneth Foust, Beaverton, OR (US); Rajasekaran Andiappan, Tampere (FI)

(21) Appl. No.: 14/178,264

(22) Filed: Feb. 11, 2014

Related U.S. Application Data
(60) Provisional application No. 61/763,916, filed on Feb. 12, 2013.

(51) Int. Cl. G06F 13/24; G06F 13/364

(52) U.S. Cl. CPC G06F 13/24; G06F 13/364
USPC 710/110; 710/262

(57) ABSTRACT

Methods, apparati, systems for including interrupt functionality in sensor interconnects field are disclosed in the present disclosure. A System on a Chip (SOC) consistent with the present disclosure includes a host and a unified sensor interconnect. A unified sensor interconnect is to be coupled to the host and at least one device. In one or more implementations, the unified sensor interconnect includes a clock line, data line, ground line, and power source line. Further, the unified sensor interconnect is to enable interrupts from at least one of the host or the at least one device.

This application claims priority to U.S. Provisional Application Ser. No. 61/763,916 entitled “A METHOD, APPARATUS, SYSTEM FOR INCLUDING INTERRUPT FUNCTIONALITY IN SENSOR INTERCONNECTS” and filed on Feb. 12, 2013.

This disclosure pertains to computing systems, and in particular (but not exclusively) to interconnect architectures for sensor devices and the like.

### BRIEF DESCRIPTION OF THE DRAWINGS

FIG. 1 illustrates an embodiment of a block diagram for a computing system including a multicore processor.

FIG. 2 illustrates an embodiment of a low power computing platform.

FIG. 3 illustrates an embodiment of different protocols to be transmitted over different physical layers of an interconnect architecture.

FIG. 4 illustrates an embodiment of a two-wire interconnect.

FIG. 5 illustrates an embodiment of a unified sensor interconnect.

FIG. 6 illustrates an embodiment of a unified sensor interconnect capable of handling interrupts.

FIG. 7 illustrates an embodiment of a method of providing an interrupt on a unified sensor interconnect.

FIG. 8 illustrates an embodiment for a method of handling an interrupt from a unified interconnect architecture.

FIG. 9 illustrates another embodiment of a block diagram for a computing system.

FIG. 10 illustrates an embodiment of a block diagram for a system on a chip.

FIG. 11 illustrates another embodiment of a block diagram for a computing system on a chip.

### DETAILED DESCRIPTION

in the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present invention. It will be apparent, however, to one skilled in the art that these specific details need not be employed to practice the present invention. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the present invention.

Although the following embodiments may be described with reference to energy conservation and energy efficiency in specific integrated circuits, such as in computing platforms or microprocessors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to desktop computer systems or Ultrabooks™. And may be also used in other devices, such as handheld devices, tablets, other thin notebooks, systems on a chip (SOC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. Moreover, the apparatus′, methods, and systems described herein are not limited to physical computing devices, but may also relate software optimizations for energy conservation and efficiency. As will become readily apparent in the description below, the embodiments of methods, apparatus′, and systems described herein (whether in reference to hardware, firmware, software, or a combination thereof) are vital to a ‘green technology’ future balanced with performance considerations.

As computing systems are advancing, the components therein are becoming more complex. As a result, the interconnect architecture to couple and communicate between the components is also increasing in complexity to ensure bandwidth requirements are met for optimal component operation. Furthermore, different market segments demand different aspects of interconnect architectures to suit the market's needs. For example, servers require higher performance, while the mobile ecosystem is sometimes able to sacrifice overall performance for power savings. Yet, it's a singular purpose of most fabrics to provide highest possible performance with maximum power saving. Below, a number of interconnects are discussed, which would potentially benefit from aspects of the invention described herein.

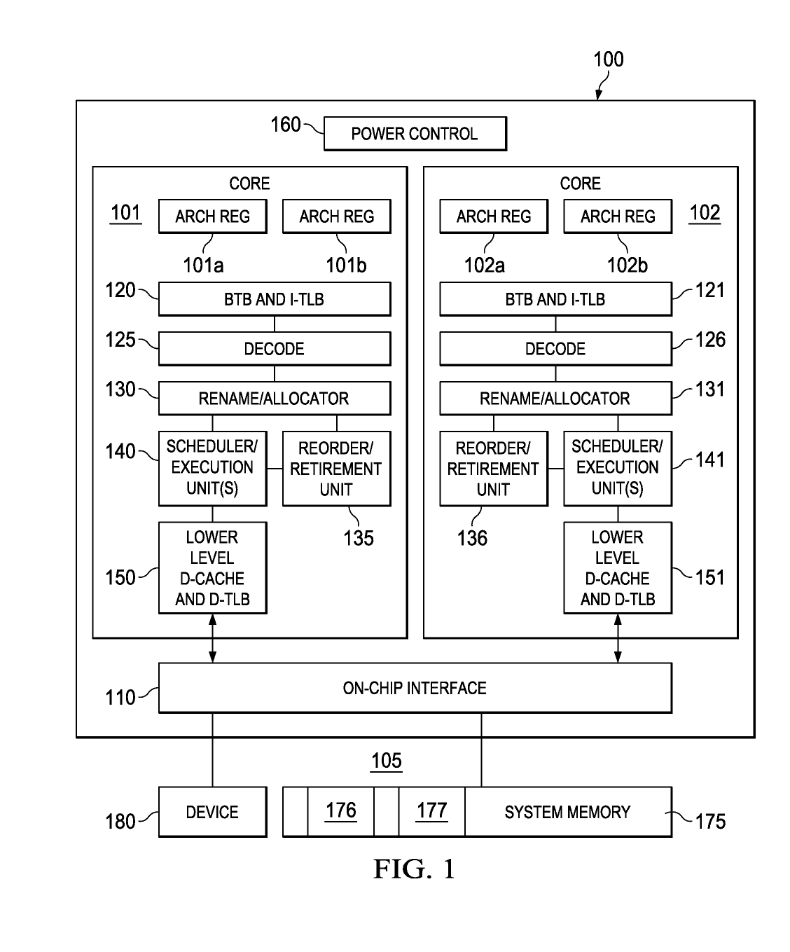

Referring to FIG. 1 an embodiment of a block diagram for a computing system including a multicore processor is depicted. Processor 100 includes any processor or processing device, such as a microprocessor, an embedded processor, a digital signal processor (DSP), a network processor, a handheld processor, an application processor, a co-processor, a system on a chip (SOC), or other device to execute code. Processor 100, in one embodiment, includes at least two cores core 101 and 102, which may include asymmetric cores or symmetric cores (the illustrated embodiment). However, processor 100 may include any number of processing elements that may be symmetric or assymetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor for processor socket) typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 100, as illustrated in FIG. 1, includes two cores core 101 and 102. Here, core 101 and 102 are considered symmetric cores, i.e. cores with the same configurations, functional units, and/or logic. In another embodiment, core 101 includes an out-of-order processor core, while core 102 includes an in-order processor core. However, cores 101 and 102 may be individually selected from any type of core, such as a native core, a software managed core, a core adapted to execute a native Instruction Set Architecture (ISA), a core adapted to execute a translated Instruction Set Architecture (ISA), a co-designed core, or other known core. In a heterogeneous core environment (i.e. asymmetric cores), some form of translation, such a binary translation, may be utilized to schedule or execute code on one or both cores. Yet to further the discussion, the functional units illustrated in core 101 are described in further detail below, as the units in core 102 operate in a similar manner in the depicted embodiment.

As depicted, core 101 includes two hardware threads 101a and 101b, which may also be referred to as hardware thread slots 101a and 101b. Therefore, software entities, such as an Operating system, in one embodiment potentially view processor 100 as four separate processors, i.e., four logical processors or processing elements capable of executing four software threads concurrently. As alluded to above, a first thread is associated with architecture state registers 101a, a second thread is associated with architecture state registers 101b, a third thread may be associated with architecture state registers 102a, and a fourth thread may be associated with architecture state registers 102b. Here, each of the architecture state registers (101a, 101b, 102a, and 102b) may be referred to as processing elements, thread slots, or thread units, as described above. As illustrated, architecture state registers 101a are replicated in architecture state registers 101b, so individual architecture states/contexts are capable of being stored for logical processor 101a and logical processor 101b. In core 101, other smaller resources, such as instruction pointers and renaming logic in allocator and renamer block 130 may also be replicated for threads 101.a and 101b. Some resources, such as re-order buffers in reorder/retirement unit 135, ILTB 120, load/store buffers, and queues may be shared through partitioning. Other resources, such as general purpose internal registers, page-table base register(s), low-level data-cache and data-TLB 115, execution unit(s) 140, and portions of out-of-order unit 135 are potentially fully shared.

Processor 100 often includes other resources, which may be fully shared, shared through partitioning, or dedicated by/to processing elements. In FIG. 1, an embodiment of a purely exemplary processor with illustrative logical units/resources of a processor is illustrated. Note that a processor may include, or omit, any of these functional units, as well as include any other known functional units, logic, or firmware not depicted. As illustrated, core 101 includes a simplified, representative out-of-order (OOO) processor core. But an in-order processor may be utilized in different embodiments. The OOO core includes a branch target buffer 120 to predict branches to be executed/taken and an instruction-translation buffer (I-TLB) 120 to store address translation entries for instructions.

Core 101 further includes decode module 1125 coupled to fetch unit 1120 to decode fetched elements. Fetch logic, in one embodiment, includes individual sequencers associated with thread slots 101a, 101b, respectively. Usually core 101 is associated with a first ISA, which defines/specifies instructions executable on processor 100. Often machine code instructions that are part of the first ISA include a portion of the instruction (referred to as an opcode), which references/specifies an instruction or operation to be performed. Decode logic 125 includes circuitry that recognizes these instructions from their opcodes and passes the decoded instructions on in the pipeline for processing as defined by the first ISA. For example, as discussed in more detail below decoders 125, in one embodiment, include logic designed or adapted to recognize specific instructions, such as transactional instruction. As a result of the recognition by decoders 125, the architecture or core 101 takes specific, predefined actions to perform tasks associated with the appropriate instruction. It is important to note that any of the tasks, blocks, operations, and methods described herein may be performed in response to a single or multiple instructions; some of which may be new or old instructions. Note decoders 126, in one embodiment, recognize the same ISA (or a subset thereof). Alternatively, in a heterogeneous core environment, decoders 126 recognize a second ISA (either a subset of the first ISA or a distinct ISA).

In one example, allocator and renamer block 130 includes an allocator to reserve resources, such as register files to store instruction processing results. However, threads 101a and 101b are potentially capable of out-of-order execution, where allocator and renamer block 130 also reserves other resources, such as reorder buffers to track instruction results. Unit 130 may also include a register renamer to rename program/instruction reference registers to other registers internal to processor 100. Reorder/retirement unit 135 includes components, such as the reorder buffers mentioned above, load buffers, and store buffers, to support out-of-order execution and later in-order retirement of instructions executed out-of-order.

Scheduler and execution unit(s) block 140, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 150 are coupled to execution unit(s) 140. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 101 and 102 share access to higher-level or further-out cache, such as a second level cache associated with on-chip interface 110. Note that higher-level or further-out refers to cache levels increasing or getting further way from the execution unit(s). In one embodiment, higher-level cache is a last-level data cache last cache in the memory hierarchy on processor 100 such as a second or third level data cache. However, higher level cache is not so limited, as it may be associated with or include an instruction cache. A trace cache a type of instruction cache—instead may be coupled after decoder 125 to store recently decoded traces. Here, an instruction potentially refers to a macro-instruction (i.e. a general instruction recognized by the decoders), which may decode into a number of micro-instructions (micro-operations).

In the depicted configuration, processor 100 also includes on-chip interface module 110. Historically, a memory controller, which is described in more detail below, has been included in a computing system external to processor 100. In this scenario, on-chip interface 110 is to communicate with devices external to processor 100, such as system memory 175, a chipset (often including a memory controller hub to connect to memory 175 and an I/O controller hub to connect peripheral devices), a memory controller hub, a northbridge, or other integrated circuit. And in this scenario, bus 105 may include any known interconnect, such as multi-drop bus, a point-to-point interconnect, a serial interconnect, a parallel bus, a coherent (e.g. cache coherent) bus, a layered protocol architecture, a differential bus, and a GTL bus.

Memory 175 may be dedicated to processor 100 or shared with other devices in a system. Common examples of types of memory 175 include DRAM, SRAM, non-volatile memory (NV memory), and other known storage devices. Note that device 180 may include a graphic accelerator, processor or card coupled to a memory controller hub, data storage coupled to an I/O controller hub, a wireless transceiver, a flash device, an audio controller, a network controller, or other known device.

Recently however, as more logic and devices are being integrated on a single die, such as SOC, each of these devices may be incorporated on processor 100. For example, in one embodiment, a memory controller hub is on the same package and/or die with processor 100. Here, a portion of the core (an on-core portion) 110 includes one or more controller(s) for interfacing with other devices such as memory 175 or a graphics device 180. The configuration including an interconnect and controllers for interfacing with such devices is often referred to as an on-core (or un-core configuration). As an example, on-chip interface 110 includes a ring interconnect for on-chip communication and a high-speed serial point-to-point link 105 for off-chip communication. Yet, in the SOC environment, even more devices, such as the network interface, co-processors, memory 175, graphics processor 180, and any other known computer devices/interface may be integrated on a single die or integrated circuit to provide small form factor with high functionality and low power consumption.

In one embodiment, processor 100 is capable of executing a compiler, optimization, and/or translator code 177 to compile, translate, and/or optimize application code 176 to support the apparatus and methods described herein or to interface therewith. A compiler often includes a program or set of programs to translate source text/code into target text/code. Usually, compilation of program/application code with a compiler is done in multiple phases and passes to transform hi-level programming language code into low-level machine or assembly language code. Yet, single pass compilers may still be utilized for simple compilation. A compiler may utilize any known compilation techniques and perform any known compiler operations, such as lexical analysis, preprocessing, parsing, semantic analysis, code generation, code transformation, and code optimization.

Larger compilers often include multiple phases, but most often these phases are included within two general phases: (1) a front-end, i.e. generally where syntactic processing, semantic processing, and some transformation/optimization may take place, and (2) aback-cod. i.e. generally where analysis, transformations, optimizations, and code generation takes place. Some compilers refer to a middle, which illustrates the blurring of delineation between a front-end and back end of a compiler. As a result, reference to insertion, association, generation, or other operation of a compiler may take place in any of the aforementioned phases or passes, as well as any other known phases or passes of a compiler. As an illustrative example, a compiler potentially inserts operations, calls, functions, etc. in one or more phases of compilation, such as insertion of calls/operations in a front-end phase of compilation and then transformation of the calls/operations into lower-level code during a transformation phase. Note that during dynamic compilation, compiler code or dynamic optimization code may insert such operations/calls, as well as optimize the code for execution during runtime. As a specific illustrative example, binary code (already compiled code) may be dynamically optimized during runtime. Here, the program code may include the dynamic optimization code, the binary code, or a combination thereof.

Similar to a compiler, a translator, such as a binary translator, translates code either statically or dynamically to optimize and/or translate code. Therefore, reference to execution of code, application code, program code, or other software environment may refer to: (1) execution of a compiler program(s), optimization code optimizer, or translator either dynamically or statically, to compile program code, to maintain software structures, to perform other operations, to optimize code, or to translate code; (2) execution of main program code including operations/calls, such as application code that has been optimized/compiled; (3) execution of other program code, such as libraries, associated with the main program code to maintain software structures, to perform other software related operations, or to optimize code; or (4) a combination thereof.

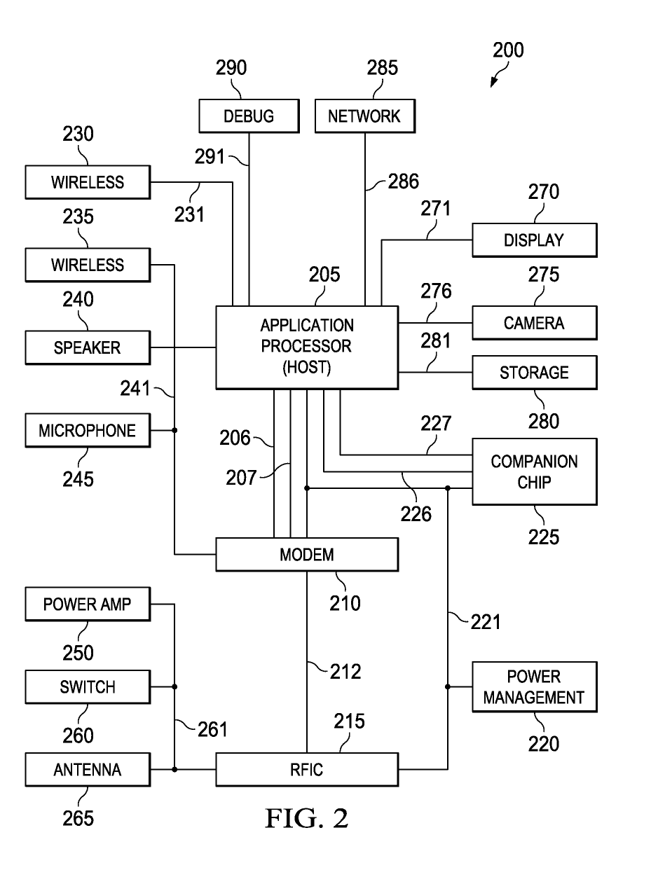

Referring to FIG. 2, an embodiment of a low power computing platform is depicted. In one embodiment, low power computing platform 200 includes a user equipment (UE). A UE refers to, in some embodiments, a device that may be used to communicate, such as a device with voice communication capability. Examples of a UE includes a phone, smartphone, tablet, ultraportable notebook, and a low power notebook. However, a low power computing platform may also refer to any other platform to obtain a lower power operating point, such as a tablet, low power notebook, an ultraportable or ultrathin notebook, a micro-server server, a low power desktop, a transmitting device, a receiving device, or any other known or available computing platform. The illustrated platform depicts a number of different interconnects to couple multiple different devices. Exemplary discussion of these interconnect are provided below to provide options on implementation and inclusion of apparatus' and methods disclosed herein. However, a low power platform 200 is not required to include or implement the depicted interconnects or devices. Furthermore, other devices and interconnect structures that are not specifically shown may be included.

The interconnect architecture described herein may replace, supplement, or augment any of the interconnects illustrated or described herein. For example, a unified sensor interconnect may replace, modify, or supplement bus 241, which may previously have been a SLIM bus.

Starting at the center of the diagram, platform 200 includes application processor 205. Often this includes a low power processor, which may be a version of a processor configuration described herein or known in the industry. As one example, processor 200 is implemented as a system on a chip (SoC). As a specific illustrative example, processor 200 includes an Intel® Architecture Core™-based processor such as an i3, i5, i7 or another such processor available from Intel Corporation, Santa Clara, Calif. However, understand that other low power processors such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters may instead be present in other embodiments such as an Apple A5/A6 processor, a Qualcomm Snapdragon processor, or TI OMAP processor. Note as the processor and SOC technologies from these companies advance, more components illustrated as separate from host processor 200 may be integrated on an SOC. As a result, similar interconnects (and inventions therein) may be used “on-die.

In one embodiment, application processor 205 runs an operating system, user interface and applications. Here, application processor 205 often recognizes or is associated with an Instruction Set Architecture (ISA) that the operating system, user interface, and applications utilize to direct processor 205's operation/execution. It also typically interfaces to sensors, cameras, displays, microphones and mass storage. Some implementations offload time critical telecom-related processing to other components.

As depicted, host processor 205 is coupled to a wireless interface 230, such as WLAN, WiGig, WirelessHD, or other wireless interface. Here an LLI, SSIC, or UniPort compliant interconnect is utilized to couple host processor 205 and wireless interface 230.

LLI stands for low latency interface. LLI typically enables memory sharing between two devices. A bidirectional interface transports memory transactions between two devices and allows a device to access the local memory of another device; often this is done without software intervention, as if it was a single device. LLI, in one embodiment, allows three classes of traffic, carrying signals over the link, reducing GPIO count. As an example, LLI defines a layered protocol stack for communication or a physical layer (PHY), such as an MPHY that is described in more detail below.

SSIC refers to SuperSpeed Inter-Chip. SSIC may enable the design of high speed USB devices using a low power physical layer. As an example, a MPHY layer is utilized, while USB 3.0 compliant protocols and software are utilized over the MPHY for better power performance.

UniPro describes a layered protocol stack with physical layer abstraction, providing a general purpose, error-handling, high speed solution for interconnecting a broad range of devices and components: application processors, co-processors, modems, and peripherals, as well as supporting different types of data traffic including control messages, bulk data transfer and packetized streaming. UniPro may support usage of an MPHY or DPHY.

Other interfaces may also couple directly to host processor 205, such as debug 290, Network 285, Display 270, camera 275, and storage 280 through other interfaces that may utilize the apparatus and methods described herein.

Debug interface 290 and network 285 communicates with application processor 205 through a debug interface 291, e.g. PTI, or network connection, e.g. a debug interface that operates over a functional network connection 285.

Display 270 includes one or more displays. In one embodiment, display 270 includes a display with one or more touch sensors capable of receiving/sensing touch input. Here, display 270 is coupled to application processor 205 through display interface (DSI) 271. DSI 271 defines protocols between host processor and peripheral devices, which may utilize a DPHY physical interface. It typically adopts pixel formats and a defined command set for video formats and signaling, such as Display Pixel Interface 2 (DPI-2), and control display module parameters, such as through a Display Command Set (DCS). As an example, DSI 271 operates at approximately 1.5 Gb/s per lane or to 6 Gb/s.

Camera 275, in one embodiment, includes an image sensor used for still pictures, video capture, or both. Front and back side cameras are common on mobile devices. Dual cameras may be used to provide stereoscopic support. As depicted, camera 275 is coupled to application processor 205 through a peripheral interconnect, such as CSI 276. CSI 276 defines an interface between a peripheral device (e.g. camera, Image Signal Processor) and a host processor (e.g. 205, baseband, application engine). In one embodiment, image data transfers are performed over a DPHY, a unidirectional differential serial interface with data and clock signals. Control of the peripheral, in one embodiment, occurs over a separate back channel, such as camera control. As an illustrative example, the speed of CSI may range from 50 Mbps-2 Gbps, or any range/value therein.

Storage 280, in one example, includes a non-volatile memory used by the application processor 205 to store large amounts of information. It may be based on Flash technology or a magnetic type of storage, such as a hard-disk. Here, 280 is coupled to processor 205 through Universal Flash Storage (UFS) interconnect 281. UFS 281, in one embodiment, includes an interconnect that is tailored for low power computing platforms, such as mobile systems. As an example, it provides between 200 and 500 MB/s transfer rate (e.g. 300 MB/s) utilizing queuing features to increase random read/write speeds. In one implementation, UFS 281 uses the MPHY physical layer and a protocol layer, such as UniPro.

Modem 210 often stands for Modulator/demodulator. The modem 210 typically provides the interface to the cellular network. It's capable of communicating with different networks types and different frequencies, depending on which communication standard is used. In one embodiment, both voice and data connections are supported. Modem 210 is coupled to host 205 utilizing any known interconnect, such as one or more of LLI, SSIC, UniPro, Mobile Express, etcetera.

In one embodiment, a control bus is utilized to couple control or data interfaces, such as wireless 235, speaker 240, and microphone 245. An example of such a bus is SLIMbus; a flexible low-power multi-drop interface capable of supporting a wide range of audio and control solutions. Other examples include PCM, I2S, I2C, SPI, and UART. Wireless 235 includes an interface, such as a short range communication standard between two devices (e.g. Bluetooth or NFC), a navigation system capable of triangulating position and/or time (e.g. GPS), a receiver for analog or radio broadcasts (e.g FM Radio), or other known wireless interface or standard. Speaker(s) 240 includes any device to generate sound, such as an electromechanical device to generate ringtones or music. Multiple speakers may be used for stereo or multi-channel sound. Microphone 245 is often utilized for voice input, such as talking during a call.

Radio Frequency Integrated Circuit (RFIC) 215 is to perform analog processing, such as processing of radio signals, e.g. amplification, mixing, filtering, and digital conversion. As depicted, RFIC 215 is coupled to modem 210 through interface 212. In one embodiment, interface 212 includes a bi-directional, high-speed interface (e.g. DigRF) that supports communication standards, such as LTE, 3GPP, EGPRS, UMTS, HSPA+, and TD-SCDMA. As a specific example, DigRF utilizes a frame-oriented protocol based on a M-PHY physical layer. DigRF is typically referred to as RF friendly, low latency, low power with optimized pin count that currently operations between 1.5 or 3 Gbps per lane and is configurable with multiple lanes, such as 4 lanes.

Interface 261 (e.g. a RF control interface) includes a flexible bus to support simple to complex devices. As a specific example, interface 261 includes a flexible two-wire serial bus, designed for control of RF Front-End components. One bus master may write and read to multiple devices, such as power amplifier 250 to amplify the RF signal, sensors to receive sensor input, switch module(s) 260 to switch between RF signal paths depending on a network mode, and antenna tuners 265 to compensate for bad antenna conditions or enhancing bandwidth. Interface 261, in one embodiment, has a group trigger function for timing-critical events and low EMI.

Power management 220 is used to provide all the different components in the mobile device 200 with power managed voltage, such as decreasing voltage or increasing it to improve efficiency for components in the mobile device. In one embodiment, it also controls and monitors the charge of the battery and remaining energy. A battery interface may be utilized between power management 220 and the battery. As an illustrative example, the battery interface includes a single-wire communication between a mobile terminal and smart/low cost batteries.

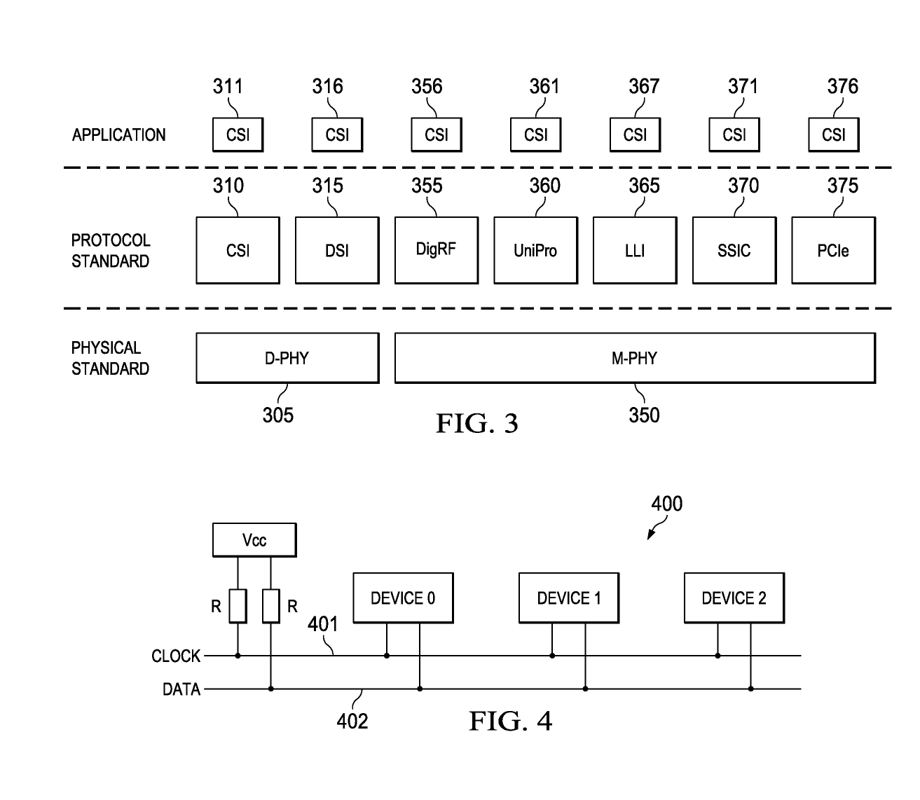

FIG. 3 illustrated an embodiment of an exemplary protocol stack for one or more of the interfaces discussed in reference to FIG. 2. For example, an interconnect may include a physical layer (PHY) to provide electrical/physical communication, while higher-level layers, such as a protocol, transaction, application, or link layer, may provide additional communication functionality. Here, MPHY 350 is capable of being implemented with a plurality of different protocol layers, such as DigRF 355, UniPro 360, LLI365, SSIC 370 (i.e. USB 3 protocols), or PCIe 375 (i.e. Mobile Express).

Typically, low speed sensors found on mobile platforms each have their own interface, protocol, and interrupt requirement. Often this includes reserving GPIO pins for each sensor on an SOC, which is potentially expensive in complexity, space, and cost. Additionally, integrating sensors with myriads of interfaces and protocols may result in a significant waste of resources.

Therefore, in one embodiment, a unified sensor interconnect is described herein. As an example, the unified interconnect is able to handle data and interrupts on the same wires, reducing the requirement of additional GPIO pins for each sensor device.

Examples of sensors include:

Mechanical/Motion: Compass/Magnetometer, Gyro, Accelerometer, Proximity, Touch Screen, Grip, Time of flight (range, optical), Ultrasonic (range, acoustic); Temperature, Carbon Monoxide/pollutants, Humidity; breathalyzer), EKG (Electrocardiogram), GSR (Galvanic skin response);

Environmental Sensing: Ambient Light, Barometric Pressure/altimeter,

Other: NFC, Haptic Feedback, IR, UV/RGB.

In one embodiment, the unified sensor interconnect includes an I2C compliant interconnect. Here, I2C compliant may refer to legacy I2C sensors being able to operate on the unified sensor interconnect in some manner. However, the unified sensor interconnect, in one embodiment, provides additional functionality.

Turning to FIG. 4, an embodiment of a unified 2 wire interconnect is illustrated. As stated above, this bus may be an I2C compliant bus. In the embodiment shown, there two wires—clock (SCL) and data (SDA). SCL is used to synchronize data transfers over the bus whereas SDA is the data line. The SCL & SDA lines are connected to devices on the bus; often in a multi-drop fashion. In one embodiment, a third wire (not shown) is provided (i.e. a ground or 0 volts). There may also be a VCC wire (e.g. a power source in the range of 240 mV to 5V, such as 1V or 1.2 V or any other voltage in the range). Both SCL and SDA lines may be “open drain” drivers (i.e. an IC may drive its output low, but doesn't drive it high). In one embodiment, for the line to go high, a pullup resistor (R) to VCC is provided for SCL and SDA.

Masters and Slaves: The devices on the I2C bus are either masters, slaves, or potentially both in a new unified sensor interconnect. The master is the device that drives the SCL clock line. The slaves are the devices that respond to the master.

I2C Physical Protocol. When the master wants to talk to a slave it begins by issuing a start sequence on the I2C bus. A start sequence is one of two special sequences defined for the I2C bus, the other being the stop sequence. The start sequence and stop sequence are special in that these may be places where the SDA (data line) is allowed to change while the SCL (clock line) is high. When data is being transferred, SDA remains stable and doesn't change while SCL is high. The start and stop sequences mark the beginning and end of a transaction.

Data, in one embodiment, is transferred in sequences of 8 bits. The bits are placed on the SDA line, as one example, starting with the MSB (Most Significant Bit). Here, the SCL line is then pulsed high, then low. In one embodiment, for every 8 bits transferred, the device receiving the data sends back an acknowledge bit, so there may be actually 9 SCL clock pulses to transfer each 8 bit byte of data. If the receiving device sends back a low ACK bit, in one example, then it has received the data and is ready to accept another byte. If it sends back a high, in this scenario, then it is indicating it cannot accept any further data and the master should terminate the transfer by sending a stop sequence.

The standard clock (SCL) speed for I2C, in one embodiment, is up to 100 KHz. However, other modes may be utilized, such as a fast mode, which is up to 400 KHz; a High Speed mode, which is up to 3.4 MHz; and an ultrafast mode, which is up to 5 MHz.

I2C Device Addressing. I2C addresses may include 7 bits or 10 bits. When sending out the 7 bit address, 8 bits may be sent. The extra bit may be used to inform the slave if the master is writing to it or reading from it. If the bit is zero, the master is writing to the slave. If the bit is 1 the master is reading from the slave. The 7 bit address is placed in the upper 7 bits of the byte and the Read/Write (R/W) bit is in the LSB (Least Significant Bit). Note, that in one embodiment, a bit of the address is utilized to indicate if the address is for an interrupt transaction or a data transaction in a unified sensor interconnect.

As illustrated in FIG. 4, the bus is coupled to device 0, 1, and 2 in a multi-drop fashion. Notec the devices may include any processor, SOC, sensor device, or other known integrated circuit.

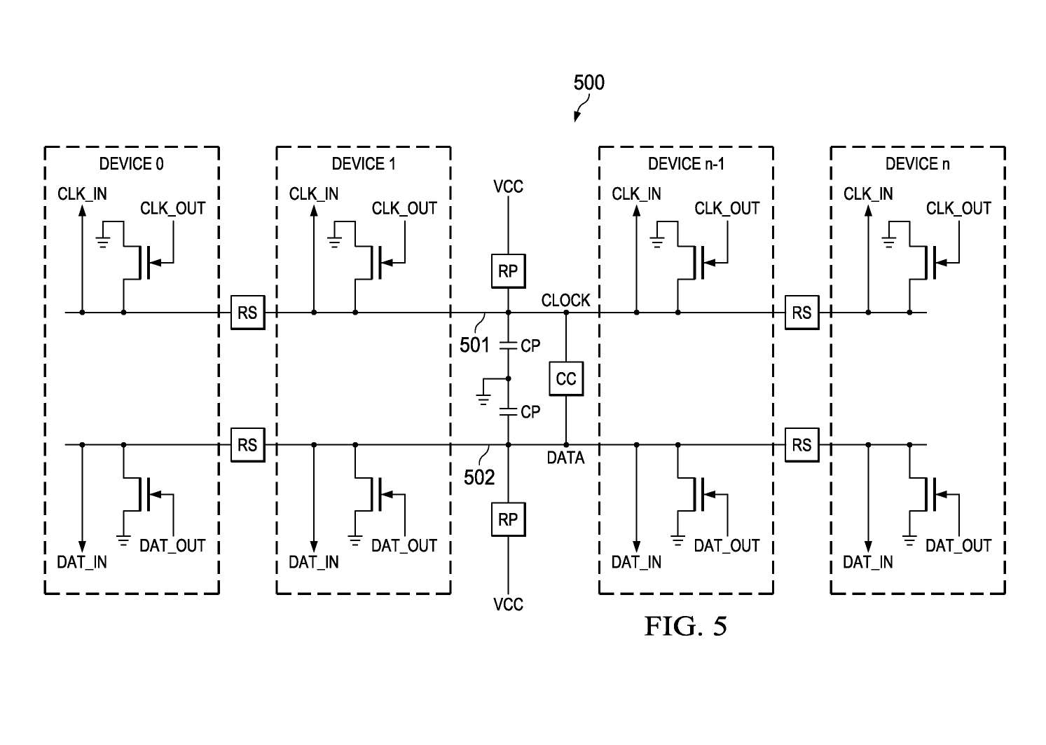

Turning to FIG. 5, an embodiment of a unified sensor interconnect architecture is illustrated. Note there are physical similarities to an I2C bus. However, in some implementations, the unified interconnect of FIG. 5 provides additional functionality. In this scenario, it could be stated that the existing I2C is augmented to provide additional functionality for sensors, such as including interrupts from the sensors, providing for dual master/slaves, allowing multi-broadcast interrupts to enable multiple device aware sensors, etc. Although usage of an I2C like bus is described in more detail below. Similar extension of a bus structure to support in-band interrupts, clock stretching for predefined periods, etc. may be performed for other buses, such as a SLIMbus.

Here, the physical layout includes 2-wires (a clock and a data wire). As a result, in one or more implementations, the unified sensor interconnect is backwards compatible with existing I2C sensors.

Note, through the connection shown in FIG. 5, the four devices, in one embodiment, are capable of being an initiator (i.e. master) and a target (i.e. slave). As a result, sensors, hubs, and processors may share a single 2-wire interface. Furthermore, as sensors grow in number rapidly, the ability to address large number of sensors on a 2-wire interface, such as 48 device, will save complexity and cost of additional GPIO pins on an SOC.

As shown in the figure, VCC is a supply voltage, which may be between 800 mV to 6V, 1.2V to 5.5V, or any number therein, such as 5V.

Data_in and Data_out include serial bit-blasted data.

Clk_in/Clk_out—includes a serial clock.

RP includes a pullup resistance. E.g. between 1-10 kOhms for current less than or equal to a mA.

Rs includes serial resistance.

CP includes wire capacitance. e.g. less than or equal to 400 pF. An increase in CP may be compensated by lowering RP to preserve signal integrity.

CC includes cross-channel capacitance.

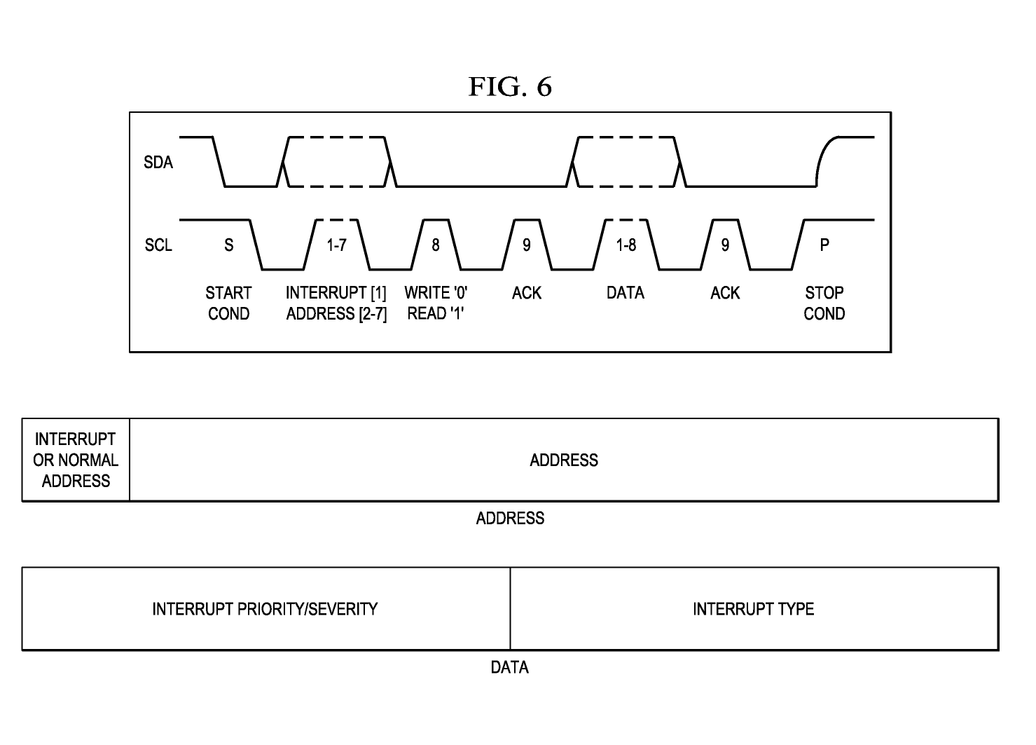

Turning to FIG. 6, an embodiment of providing a unified sensor interconnect capable of enabling inband interrupts is illustrated. In one embodiment, the unified interconnect is able to support (address a range of 32-64 devices, such as 48 devices). In one implementation, the unified interconnect is also able to support previous I2C compliant sensors (i.e. backwards compatibility with existing I2C sensors) which may require additional GPIO pins in the short-term, however, but may allow sensor vendors or system manufacturers to continue with legacy sensors.

Previously, as stated above, in an I2C only example, an address includes 7 bits. In one embodiment, the unified sensor interconnect utilizes a portion of the address to (i.e. overloading the address) to indicate a transaction includes an interrupt. In this scenario, 1 bit is utilized to indicate if the transaction is an interrupt transaction or normal access (i.e. data transaction). As shown, the 1 bit includes the MSB. And when the MSB is an active high, then transaction includes an interrupt.

However, in some implementations it may be elsewhere in the address, such as the LSB. Note that use of a single bit in the address is also exemplary. Instead, a special start sequence may be utilized, such as two start sequences in succession. Moreover, the actual logic state (High) to indicate an interrupt may be inverted (i.e. a logical low to indicate an interrupt).

Returning to the example, the 6 remaining bits would be able to address 64 devices. Yet, in one embodiment, the 6 bits allow for addressing of up to 48 devices and 12 special purpose addresses. As an example, a map may include two of the 12 purpose addresses into the 6 bit-range (e.g. 11110xx—special purpose slave address; and 11111xx—reserved). However, these addressing schemes are purely illustrative. Any number of bits may be utilized to indicate transaction type (interrupt, data, or other) and any number of those bits may be utilized to address devices or reserved for special/future purposes.

As a result, in the illustrated example, a bit (the MSB) indicates if the transaction is an interrupt, the remaining 6 bits are utilized as an address map, and the 8th bit is to indicate a r/w. Moreover, as stated above, a 9th bit may be sent (an ACK from the target device).

Previously, in I2C an address and data were sent for a normal access transaction (data transaction). However, in the new unified architecture, inband interrupts are supported, such as in the example above. As a result, the data part of the transaction that follows the address may be utilized to specify interrupt information.

As an example, data 1-4 may be utilized to indicate the interrupt severity or priority (e.g. 4′b0000 is a least critical and 4′b1111 is the most critical; or the inverse). Additionally, data 5-8 may be utilized to specify a type of interrupt. Any known interrupt type, such as those commonly used in computer systems may be included here. With 4 bits, up to 16 types may be specified.

As a result of the enhanced, unified sensor interconnect, cost savings for GPIO pins may be achieved, driver and API development efforts may be reduced using an unified protocol, low-speed sensors may be comprehensively integrated with a low cost solution, SOC platform time to market may be reduced, and legacy I2C sensors may still be utilized.

In one embodiment, unified sensor interconnect devices include master and slave functionality. Here, the master may generate inband interrupts while the slave monitors the bus so not to send interrupts when the bus is in use.

Furthermore, the inclusion of inband interrupts in a multi-drop environment enables sensors to become device (or sensor) aware. In other words, any device may communicate pertinent information by broadcasting interrupts to all devices inband. As a consequence of awareness, sensor devices may become more intelligent and offload all or considerable amount of the communication and processing from the application processor/host devices; contributing to significant enhancements in user experience and power reduction. Improved efficiencies from offloading extra cycles in the bus, and extending the power-saving/sleep state of more devices on the bus (such as the host), may contribute to reduced power dissipation.

For example, a GPS and Host may be initiators, whereas a Gyro and Accelerometer may be targets. Here, sensor devices (GPS, Gyro, Accelerometer) may intelligently share information amongst themselves without any assistance from the Host device, and significantly extend sleep-state of the Host device. In addition, collaboration amongst the devices using inband interrupt protocol results in wholistic and significantly enhanced user experience without requiring proliferation of the traditional dedicated (GPIO) pins to be instantiated amongst multiple devices.

In one embodiment, the unified sensor bus constrains auto-increment (DMA) to a limit, such as 16, 32, or 64 bytes which may bound system latency.

In one embodiment, both a master and a slave are able to stretch the clock (i.e. hold it low to ensure other devices are not initiating). Yet, in one embodiment, a limit to clock stretch is provided to prevent starvation. As a specific example, a 1 millisecond limit is imposed. However, the limit may be any amount of time, such as a predetermined amount within a range of 100 microseconds to 100 milliseconds.

As stated above, in one embodiment, legacy I2C sensors are capable of being utilized. Here, a legacy sensor, in some implementations, may avoid setting the MSB high to ensure a data transaction from a legacy sensor is not misinterpreted as an interrupt. Note, these legacy sensors may use additional GPIO pins on an SOC. However, any new sensors will be able to communicate on the 2-wire bus, which allows multiple devices to occupy only the two pins on the SOC, as well as the power and ground often associated with signal pins.

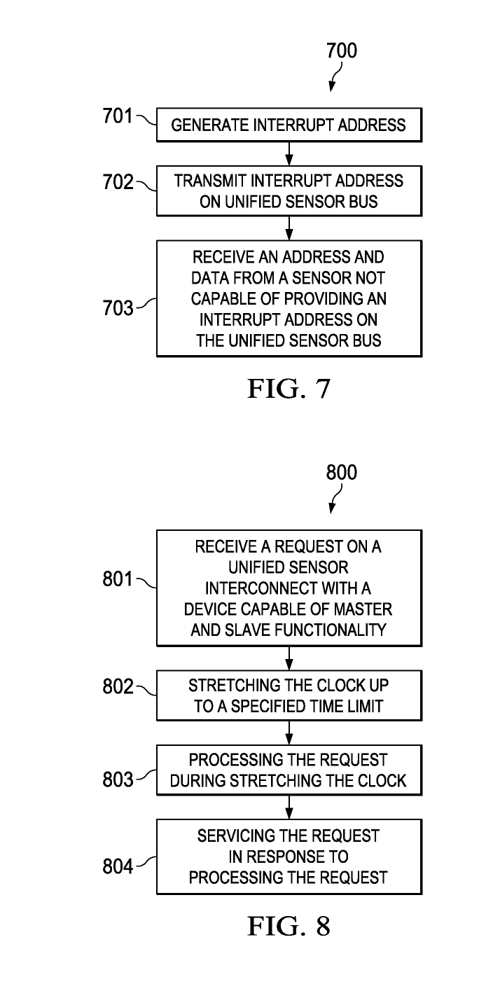

Turning to FIG. 7, an embodiment of a method (flowchart 700) for providing inband interrupts is illustrated. An interrupt address is generated (701). Note the interrupt address may be compliant with any of the aforementioned examples. As a specific illustrated, a MSB of the address is set high to indicate the transaction is an interrupt, the remaining 6 bits are utilized for addressing (48 devices, 12 special addresses), 1 bit is utilized to indicate a write, and a 9th bit provides as an acknowledgement from the target device.

The interrupt is transmitted on a unified sensor bus (702). Here, the bus may be I2C compliant (i.e. I2C like bus that supports the additional functionality of the unified sensor bus described herein). Continuing the example, the device initiates a special start sequence and then transmits the aforementioned address information on the two-wire multi-drop bus.

The target device, such as a sensor or SOC, receives the information (703). In one embodiment, the target device may be a legacy I2C sensor. In this case, the sensor may be able to receive such data, but it may not be able to reply in a similar manner (i.e. it can provide a data transaction but not an inband interrupt). Instead of inband it may provide an interrupt out of band (through separate GPIO pins to the SOC.

In one embodiment, the unified sensor interconnect is able to support devices in different power states, such as an active, low power, sleep, deep-sleep, or other known power state. As one example, a wake sequence for a device in a deep-sleep power state could be the following: initiate exit from sleep using low-power sense circuit to monitor SDA Hi_Lo, followed by SCL Hi_Lo transition on the data and clock bus respectively; Kick start PLL spin-up/power up sequence in the recipient Device; Recipient Device stores the incoming Interrupt/Address/Data packets in a holding buffer using the clock from SCL bus; and Once the PLL has spun-up and power-up sequence has been completed, recipient Device generates the ACK on SDA bus. The aforementioned functionality is made possible since clock-stretching is permitted.

Turning to FIG. 8, an embodiment of a method (flowchart 800) for servicing an inband interrupt from a unified sensor bus is illustrated. A request is received from a unified sensor interconnect, such as an inband interrupt described above (801). Here, the target device (slave) stretches the clock for a period of time, while it processes the request (802). However, in one embodiment, a limit (e.g. 1 millisecond) is provided on the amount of time the slave may stretch the clock (802). When the limit expires or the device has processed the request (803), the clock is released. And if the request was processed in time, it is serviced by the target device (804). Note this may only include the internal processing of the interrupt or it may include some reply or action on behalf of the target device.

Note that the apparatus', methods', and systems described above may be implemented in any electronic device or system as aforementioned. As specific illustrations, the figures below provide exemplary systems for utilizing the invention as described herein. As the systems below are described in more detail, a number of different interconnects are disclosed, described, and revisited from the discussion above. And as is readily apparent, the advances described above may be applied to any of those interconnects, fabrics, or architectures.

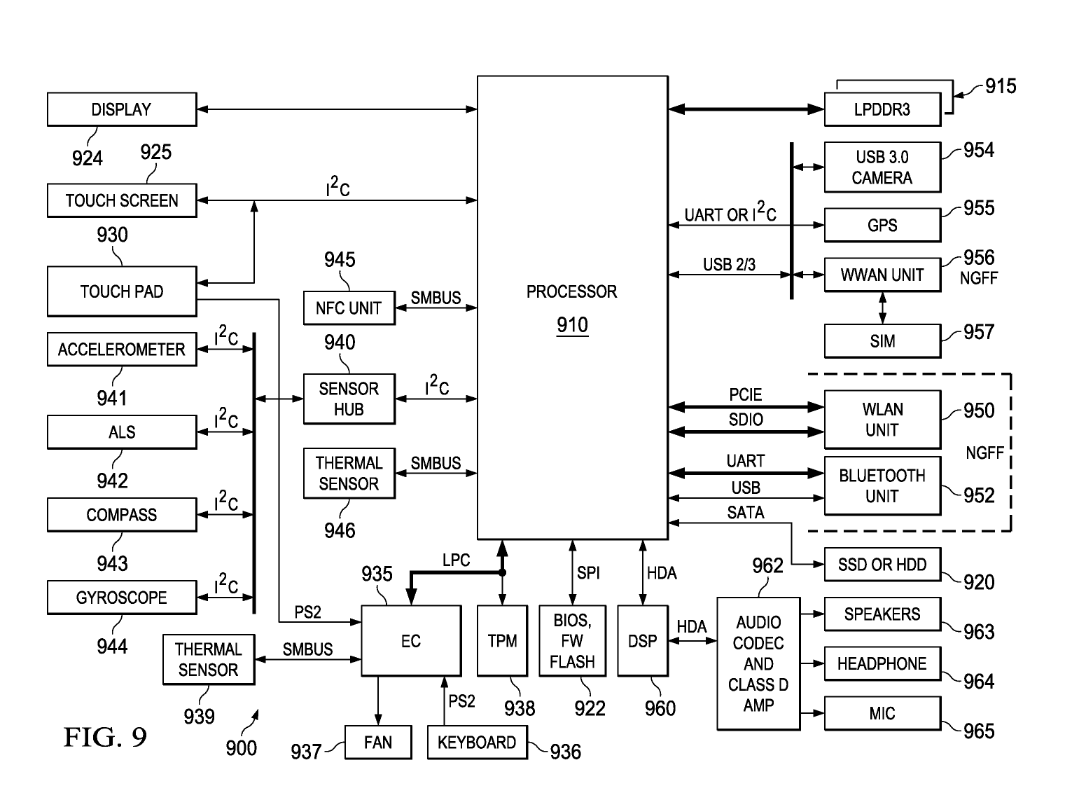

Referring now to FIG. 9, a block diagram of components present in a computer system in accordance with an embodiment of the present invention is illustrated. As shown in FIG. 9, system 900 includes any combination of components. These components may be implemented as ICs, portions thereof, discrete electronic devices, or other modules, logic, hardware, software, firmware, or a combination thereof adapted in a computer system, or as components otherwise incorporated within a chassis of the computer system. Note also that the block diagram of FIG. 9 is intended to show a high level view of many components of the computer system. However, it is to be understood that some of the components shown may be omitted, additional components may be present, and different arrangement of the components shown may occur in other implementations. As a result, the invention described above may be implemented in any portion of one or more of the interconnects illustrated or described below.

As seen in FIG. 9, a processor 910, in one embodiment, includes a microprocessor, multi-core processor, multithreaded processor, an ultra low voltage processor, an embedded processor, or other known processing element. In the illustrated implementation, processor 910 acts as a main processing unit and central hub for communication with many of the various components of the system 900. As one example, processor 900 is implemented as a system on a chip (SOC). As a specific illustrative example, processor 910 includes an Intel® Architecture Core™-based processor such as an i3, i5, i7 or another such processor available from Intel Corporation, Santa Clara, Calif. However, understand that other low power processors such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters may instead be present in other embodiments such as an Apple A5/A6 processor, a Qualcomm Snapdragon processor, or TI OMAP processor. Note that many of the customer versions of such processors are modified and varied; however, they may support or recognize a specific instructions set that performs defined algorithms as set forth by the processor licensor. Here, the microarchitectural implementation may vary, but the architectural function of the processor is usually consistent. Certain details regarding the architecture and operation of processor 910 in one implementation will be discussed further below to provide an illustrative example.

Processor 910, in one embodiment, communicates with a system memory 915. As an illustrative example, which in an embodiment can be implemented via multiple memory devices to provide for a given amount of system memory. As examples, the memory can be in accordance with a Joint Electron Devices Engineering Council (JEDEC) low power double data rate (LPDDR)-based design such as the current LPDDR2 standard according to JEDEC JESD 209-2E (published April 2009), or a next generation LPDDR standard to be referred to as LPDDR3 or LPDDR4 that will offer extensions to LPDDR2 to increase bandwidth. In various implementations the individual memory devices may be of different package types such as single die package (SDP), dual die package (DDP) or quad die package (Q17P). These devices, in some embodiments, are directly soldered onto a motherboard to provide a lower profile solution, while in other embodiments the devices are configured as one or more memory modules that in turn couple to the motherboard by a given connector. And of course, other memory implementations are possible such as other types of memory modules, e.g., dual inline memory modules (DIMMs) of different varieties including but not limited to microDIMMs, MiniDIMMs. In a particular illustrative embodiment, memory is sized between 2 GB and 16 GB, and may be configured as a DDR3LM package or an LPDDR2 or LPDDR3 memory that is soldered onto a motherboard via a ball grid array (BGA).

To provide for persistent storage of information such as data, applications, one or more operating systems and so forth, a mass storage 920 may also couple to processor 910. In various embodiments, to enable a thinner and lighter system design as well as to improve system responsiveness, this mass storage may be implemented via a SSD. However in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also shown in FIG. 9, a flash device 922 may be coupled to processor 910, e.g., via a serial peripheral interface (SPI). This flash device may provide for non-volatile storage of system software, including a basic input/output software (BIOS) as well as other firmware of the system.

In various embodiments, mass storage of the system is implemented by a SSD alone or as a disk, optical or other drive with an SSD cache. In some embodiments, the mass storage is implemented as a SSD or as a HDD along with a restore (RST) cache module. In various implementations, the HDD provides for storage of between 320 GB-4 terabytes (TB) and upward while the RST cache is implemented with a SSD having a capacity of 24 GB-256 GB. Note that such SSD cache may be configured as a single level cache (SLC) or multi-level cache (MLC) option to provide an appropriate level of responsiveness. In a SSD-only option, the module may be accommodated in various locations such as in a mSATA or NGFF slot. As an example, an SSD has a capacity ranging from 120 GB-1 TB.

Various input/output (IO) devices may be present within system 900. Specifically shown in the embodiment of FIG. 9 is a display 924 which may be a high definition LCD or LED panel configured within a lid portion of the chassis. This display panel may also provide for a touch screen 925, e.g., adapted externally over the display panel such that via a user's interaction with this touch screen, user inputs can be provided to the system to enable desired operations, e.g., with regard to the display of information, accessing of information and so forth.

In one embodiment, display 924 may be coupled to processor 910 via a display interconnect that can be implemented as a high performance graphics interconnect. Touch screen 925 may be coupled to processor 910 via another interconnect, which in an embodiment can be an I2C interconnect. As further shown in FIG. 9, in addition to touch screen 925, user input by way of touch can also occur via a touch pad 930 which may be configured within the chassis and may also be coupled to the same I2C interconnect as touch screen 925.

The display panel may operate in multiple modes. In a first mode, the display panel can be arranged in a transparent state in which the display panel is transparent to visible light. In various embodiments, the majority of the display panel may be a display except for a bezel around the periphery. When the system is operated in a notebook mode and the display panel is operated in a transparent state, a user may view information that is presented on the display panel while also being able to view objects behind the display. In addition, information displayed on the display panel may be viewed by a user positioned behind the display. Or the operating state of the display panel can be an opaque state in which visible light does not transmit through the display panel.

In a tablet mode, the system is folded shut such that the back display surface of the display panel comes to rest in a position such that it faces outwardly towards a user, when the bottom surface of the base panel is rested on a surface or held by the user. In the tablet mode of operation, the back display surface performs the role of a display and user interface, as this surface may have touch screen functionality and may perform other known functions of a conventional touch screen device, such as a tablet device. To this end, the display panel may include a transparency-adjusting layer that is disposed between a touch screen layer and a front display surface. In some embodiments the transparency-adjusting layer may be an electrochromic layer (EC), a LCD layer, or a combination of EC and LCD layers.

In various embodiments, the display can be of different sizes, e.g., an 11.6″ or a 13.3″ screen, and may have a 16:9 aspect ratio, and at least 300 nits brightness. Also the display may be of full high definition (HD) resolution (at least 1920×1080p), be compatible with an embedded display port (eDP), and be a low power panel with panel self refresh.

As to touch screen capabilities, the system may provide for a display multi-touch panel that is multi-touch capacitive and being at least 5 finger capable. And in some embodiments, the display may be 10 finger capable. In one embodiment, the touch screen is accommodated within a damage and scratch-resistant glass and coating (e.g., Gorilla Glass™ or Gorilla Glass 2™) for low friction to reduce “finger burn” and avoid “finger skipping”. To provide for an enhanced touch experience and responsiveness, the touch panel, in some implementations, has multi-touch functionality, such as less than 2 frames (30 Hz) per static view during pinch zoom, and single-touch functionality of less than 1 cm per frame (30 Hz) with 200 ms (lag on finger to pointer). The display, in some implementations, supports edge-to-edge glass with a minimal screen bezel that is also flush with the panel surface, and limited IO interference when using multi-touch.

For perceptual computing and other purposes, various sensors may be present within the system and may be coupled to processor 910 in different manners. Certain inertial and environmental sensors may couple to processor 910 through a sensor hub 940, e.g., via an I2C interconnect with the enhancements described herein. In the embodiment shown in FIG. 9, these sensors may include an accelerometer 941, an ambient light sensor (ALS) 942, a compass 943 and a gyroscope 944. Other environmental sensors may include one or more thermal sensors 946 which in some embodiments couple to processor 910 via a system management bus (SMBus) bus.

Using the various inertial and environmental sensors present in a platform, many different use cases may be realized. These use cases enable advanced computing operations including perceptual computing and also allow for enhancements with regard to power management/battery life, security, and system responsiveness.

For example with regard to power management/battery life issues, based at least on part on information from an ambient light sensor, the ambient light conditions in a location of the platform are determined and intensity of the display controlled accordingly. Thus, power consumed in operating the display is reduced in certain light conditions.

As to security operations, based on context information obtained from the sensors such as location information, it may be determined whether a user is allowed to access certain secure documents. For example, a user may be permitted to access such documents at a work place or a home location. However, the user is prevented from accessing such documents when the platform is present at a public location. This determination, in one embodiment, is based on location information, e.g., determined via a GPS sensor or camera recognition of landmarks. Other security operations may include providing for pairing of devices within a close range of each other, e.g., a portable platform as described herein and a user's desktop computer, mobile telephone or so forth. Certain sharing, in some implementations, are realized via near field communication when these devices are so paired. However, when the devices exceed a certain range, such sharing may be disabled. Furthermore, when pairing a platform as described herein and a smartphone, an alarm may be configured to be triggered when the devices move more than a predetermined distance from each other, when in a public location. In contrast, when these paired devices are in a safe location, e.g., a work place or home location, the devices may exceed this predetermined limit without triggering such alarm.

Responsiveness may also be enhanced using the sensor information. For example, even when a platform is in a low power state, the sensors may still be enabled to run at a relatively low frequency. Accordingly, any changes in a location of the platform, e.g., as determined by inertial sensors, GPS sensor, or so forth is determined. If no such changes have been registered, a faster connection to a previous wireless hub such as a Wi-Fi™ access point or similar wireless enabler occurs, as there is no need to scan for available wireless network resources in this case. Thus, a greater level of responsiveness when waking from a low power state is achieved.

It is to be understood that many other use cases may be enabled using sensor information obtained via the integrated sensors within a platform as described herein, and the above examples are only for purposes of illustration. Using a system as described herein, a perceptual computing system may allow for the addition of alternative input modalities, including gesture recognition, and enable the system to sense user operations and intent.

In some embodiments one or more infrared or other heat sensing elements, or any other element for sensing the presence or movement of a user may be present. Such sensing elements may include multiple different elements working together, working in sequence, or both. For example, sensing elements include elements that provide initial sensing, such as light or sound projection, followed by sensing for gesture detection by, for example, an ultrasonic time of flight camera or a patterned light camera.

Also in some embodiments, the system includes a light generator to produce an illuminated line. In some embodiments, this line provides a visual cue regarding a virtual boundary, namely an imaginary or virtual location in space, where action of the user to pass or break through the virtual boundary or plane is interpreted as an intent to engage with the computing system. In some embodiments, the illuminated line may change colors as the computing system transitions into different states with regard to the user. The illuminated line may be used to provide a visual cue for the user of a virtual boundary in space, and may be used by the system to determine transitions in state of the computer with regard to the user, including determining when the user wishes to engage with the computer.

In some embodiments, the computer senses user position and operates to interpret the movement of a hand of the user through the virtual boundary as a gesture indicating an intention of the user to engage with the computer. In some embodiments, upon the user passing through the virtual line or plane the light generated by the light generator may change, thereby providing visual feedback to the user that the user has entered an area for providing gestures to provide input to the computer.

Display screens may provide visual indications of transitions of state of the computing system with regard to a user. In some embodiments, a first screen is provided in a first state in which the presence of a user is sensed by the system, such as through use of one or more of the sensing elements.

In some implementations, the system acts to sense user identity, such as by facial recognition. Here, transition to a second screen may be provided in a second state, in which the computing system has recognized the user identity, where this second the screen provides visual feedback to the user that the user has transitioned into a new state. Transition to a third screen may occur in a third state in which the user has confirmed recognition of the user.

In some embodiments, the computing system may use a transition mechanism to determine a location of a virtual boundary for a user, where the location of the virtual boundary may vary with user and context. The computing system may generate a light, such as an illuminated line, to indicate the virtual boundary for engaging with the system. In some embodiments, the computing system may be in a waiting state, and the light may be produced in a first color. The computing system may detect whether the user has reached past the virtual boundary, such as by sensing the presence and movement of the user using sensing elements.

In some embodiments, if the user has been detected as having crossed the virtual boundary (such as the hands of the user being closer to the computing system than the virtual boundary line), the computing system may transition to a state for receiving gesture inputs from the user, where a mechanism to indicate the transition may include the light indicating the virtual boundary changing to a second color.

In some embodiments, the computing system may then determine whether gesture movement is detected. If gesture movement is detected, the computing system may proceed with a gesture recognition process, which may include the use of data from a gesture data library, which may reside in memory in the computing device or may be otherwise accessed by the computing device.

If a gesture of the user is recognized, the computing system may perform a function in response to the input, and return to receive additional gestures if the user is within the virtual boundary. In some embodiments, if the gesture is not recognized, the computing system may transition into an error state, where a mechanism to indicate the error state may include the light indicating the virtual boundary changing to a third color, with the system returning to receive additional gestures if the user is within the virtual boundary for engaging with the computing system.

As mentioned above, in other embodiments the system can be configured as a convertible tablet system that can be used in at least two different modes, a tablet mode and a notebook mode. The convertible system may have two panels, namely a display panel and a base panel such that in the tablet mode the two panels are disposed in a stack on top of one another. In the tablet mode, the display panel faces outwardly and may provide touch screen functionality as found in conventional tablets. In the notebook mode, the two panels may be arranged in an open clamshell configuration.

In various embodiments, the accelerometer may be a 3-axis accelerometer having data rates of at least 50 Hz. A gyroscope may also be included, which can be a 3-axis gyroscope. In addition, an e-compass/magnetometer may be present. Also, one or more proximity sensors may be provided (e.g., for lid open to sense when a person is in proximity (or not) to the system and adjust power/performance to extend battery life). For some OS's Sensor Fusion capability including the accelerometer, gyroscope, and compass may provide enhanced features. In addition, via a sensor hub having a real-time clock (RTC), a wake from sensors mechanism may be realized to receive sensor input when a remainder of the system is in a low power state.

In some embodiments, an internal lid/display open switch or sensor to indicate when the lid is closed/open, and can be used to place the system into Connected Standby or automatically wake from Connected Standby state. Other system sensors can include ACPI sensors for internal processor, memory, and skin temperature monitoring to enable changes to processor and system operating states based on sensed parameters.

In an embodiment, the OS may be a Microsoft® Windows® 8 OS that implements Connected Standby (also referred to herein as Win8 CS). Windows 8 Connected Standby or another OS having a similar state can provide, via a platform as described herein, very low ultra idle power to enable applications to remain connected, e.g., to a cloud-based location, at very low power consumption. The platform can supports 3 power states, namely screen on (normal); Connected Standby (as a default “off” state); and shutdown (zero watts of power consumption). Thus in the Connected Standby state, the platform is logically on (at minimal power levels) even though the screen is off. In such a platform, power management can be made to be transparent to applications and maintain constant connectivity, in part due to offload technology to enable the lowest powered component to perform an operation.

Also seen in FIG. 9, various peripheral devices may couple to processor 910 via a low pin count (LPC) interconnect. In the embodiment shown, various components can be coupled through an embedded controller 935. Such components can include a keyboard 936 (e.g., coupled via a PS2 interface), a fan 937, and a thermal sensor 939. In some embodiments, touch pad 930 may also couple to EC 935 via a PS2 interface. In addition, a security processor such as a trusted platform module (TPM) 938 in accordance with the Trusted Computing Group (TCG) TPM Specification Version 1.2, dated Oct. 2, 2003, may also couple to processor 910 via this LPC interconnect. However, understand the scope of the present invention is not limited in this regard and secure processing and storage of secure information may be in another protected location such as a static random access memory (SRAM) in a security coprocessor, or as encrypted data blobs that are only decrypted when protected by a secure enclave (SE) processor mode.

In a particular implementation, peripheral ports may include a high definition media interface (HDMI) connector (which can be of different form factors such as full size, mini or micro); one or more USB ports, such as full-size external ports in accordance with the Universal Serial Bus Revision 3.0 Specification (November 2008), with at least one powered for charging of USB devices (such as smartphones) when the system is in Connected Standby state and is plugged into AC wall power. In addition, one or more Thunderbolt™ ports can be provided. Other ports may include an externally accessible card reader such as a full size SDXC card reader and/or a SIM card reader for WWAN (e.g., an 8 pin card reader). For audio, a 3.5 mm jack with stereo sound and microphone capability (e.g., combination functionality) can be present, with support for jack detection (e.g., headphone only support using microphone in the lid or headphone with microphone in cable). In some embodiments, this jack can be re-taskable between stereo headphone and stereo microphone input. Also, a power jack can be provided for coupling to an AC brick.

System 900 can communicate with external devices in a variety of manners, including wirelessly. In the embodiment shown in FIG. 9, various wireless modules, each of which can correspond to a radio configured for a particular wireless communication protocol, are present. One manner for wireless communication in a short range such as a near field may be via a near field communication (NFC) unit 945 which may communicate, in one embodiment with processor 910 via an SMBus. Note that via this NFC unit 945, devices in close proximity to each other can communicate. For example, a user can enable system 900 to communicate with another (e.g.,) portable device such as a smartphone of the user via adapting the two devices together in close relation and enabling transfer of information such as identification information payment information, data such as image data or so forth. Wireless power transfer may also be performed using a NFC system.

Using the NFC unit described herein, users can bump devices side-to-side and place devices side-by-side for near field coupling functions (such as near field communication and wireless power transfer (WPT)) by leveraging the coupling between coils of one or more of such devices. More specifically, embodiments provide devices with strategically shaped, and placed, ferrite materials, to provide for better coupling of the coils. Each coil has an inductance associated with it, which can be chosen in conjunction with the resistive, capacitive, and other features of the system to enable a common resonant frequency for the system.

As further seen in FIG. 9, additional wireless units can include other short range wireless engines including a WLAN unit 950 and a Bluetooth unit 952. Using WLAN unit 950, Wi-Fi™ communications in accordance with a given Institute of Electrical and Electronics Engineers (IEEE) 802.11 standard can be realized, while via Bluetooth unit 952, short range communications via a Bluetooth protocol can occur. These units may communicate with processor 910 via, e.g., a USB link or a universal asynchronous receiver transmitter (UART) link. Or these units may couple to processor 910 via an interconnect according to a Peripheral Component Interconnect Express™ (PCIe™) protocol, e.g., in accordance with the PCI Express™ Specification Base Specification version 3.0 (published Jan. 17, 2007), or another such protocol such as a serial data input/output (SDIO) standard. Of course, the actual physical connection between these peripheral devices, which may be configured on one or more add-in cards, can be by way of the NGFF connectors adapted to a motherboard.

In addition, wireless wide area communications, e.g., according to a cellular or other wireless wide area protocol, can occur via a WWAN unit 956 which in turn may couple to a subscriber identity module (SIM) 957. In addition, to enable receipt and use of location information, a GPS module 955 may also be present. Note that in the embodiment shown in FIG. 9, WWAN unit 956 and an integrated capture device such as a camera module 954 may communicate via a given USB protocol such as a USB 2.0 or 3.0 link, or a UART or I2C protocol. Again the actual physical connection of these units can be via adaptation of a NGFF add-in card to an NGFF connector configured on the motherboard.

In a particular embodiment, wireless functionality can be provided modularly, e.g., with a WiFi™ 802.11ac solution (e.g., add-in card that is backward compatible with IEEE 802.11abgn) with support for Windows 8 CS. This card can be configured in an internal slot (e.g., via an NGFF adapter). An additional module may provide for Bluetooth capability (e.g., Bluetooth 4.0 with backwards compatibility) as well as Intel® Wireless Display functionality. In addition NFC support may be provided via a separate device or multi-function device, and can be positioned as an example, in a front right portion of the chassis for easy access. A still additional module may be a WWAN device that can provide support for 3G/4G/LTE and GPS. This module can be implemented in an internal (e.g., NGFF) slot. Integrated antenna support can be provided for WiFi™, Bluetooth, WWAN, NFC and GPS, enabling seamless transition from WiFi™ to WWAN radios, wireless gigabit (WiGig) in accordance with the Wireless Gigabit Specification (July 2010), and vice versa.

As described above, an integrated camera can be incorporated in the lid. As one example, this camera can be a high resolution camera, e.g., having a resolution of at least 2.0 megapixels (MP) and extending to 6.0 MP and beyond.

To provide for audio inputs and outputs, an audio processor can be implemented via a digital signal processor (DSP) 960, which may couple to processor 910 via a high definition audio (HDA) link. Similarly, DSP 960 may communicate with an integrated coder/decoder (CODEC) and amplifier 962 that in turn may couple to output speakers 963 which may be implemented within the chassis. Similarly, amplifier and CODEC 962 can be coupled to receive audio inputs from a microphone 965 which in an embodiment can be implemented via dual array microphones (such as a digital microphone array) to provide for high quality audio inputs to enable voice-activated control of various operations within the system. Note also that audio outputs can be provided from amplifier/CODEC 962 to a headphone jack 964. Although shown with these particular components in the embodiment of FIG. 9, understand the scope of the present invention is not limited in this regard.

In a particular embodiment, the digital audio codec and amplifier are capable of driving the stereo headphone jack, stereo microphone jack, an internal microphone array and stereo speakers. In different implementations, the codec can be integrated into an audio DSP or coupled via an HD audio path to a peripheral controller hub (PCH). In some implementations, in addition to integrated stereo speakers, one or more bass speakers can be provided, and the speaker solution can support DTS audio.

In some embodiments, processor 910 may be powered by an external voltage regulator (VR) and multiple internal voltage regulators that are integrated inside the processor die, referred to as fully integrated voltage regulators (FIVRs). The use of multiple FIVRs in the processor enables the grouping of components into separate power planes, such that power is regulated and supplied by the FIVR to only those components in the group. During power management, a given power plane of one FIVR may be powered down or off when the processor is placed into a certain low power state, while another power plane of another FIVR remains active, or fully powered.

In one embodiment, a sustain power plane can be used during some deep sleep states to power on the I/O pins for several I/O signals, such as the interface between the processor and a PCH, the interface with the external VR and the interface with EC 935. This sustain power plane also powers an on-die voltage regulator that supports the on-board SRAM or other cache memory in which the processor context is stored during the sleep state. The sustain power plane is also used to power on the processor's wakeup logic that monitors and processes the various wakeup source signals.

During power management, while other power planes are powered down or off when the processor enters certain deep sleep states, the sustain power plane remains powered on to support the above-referenced components. However, this can lead to unnecessary power consumption or dissipation when those components are not needed. To this end, embodiments may provide a connected standby sleep state to maintain processor context using a dedicated power plane. In one embodiment, the connected standby sleep state facilitates processor wakeup using resources of a PCH which itself may be present in a package with the processor. In one embodiment, the connected standby sleep state facilitates sustaining processor architectural functions in the PCH until processor wakeup, this enabling turning off all of the unnecessary processor components that were previously left powered on during deep sleep states, including turning off all of the clocks. In one embodiment, the PCH contains a time stamp counter (TSC) and connected standby logic for controlling the system during the connected standby state. The integrated voltage regulator for the sustain power plane may reside on the PCH as well.

In an embodiment, during the connected standby state, an integrated voltage regulator may function as a dedicated power plane that remains powered on to support the dedicated cache memory in which the processor context is stored such as critical state variables when the processor enters the deep sleep states and connected standby state. This critical state may include state variables associated with the architectural, micro-architectural, debug state, and/or similar state variables associated with the processor.

The wakeup source signals from EC 935 may be sent to the PCH instead of the processor during the connected standby state so that the PCH can manage the wakeup processing instead of the processor. In addition, the TSC is maintained in the PCH to facilitate sustaining processor architectural functions. Although shown with these particular components in the embodiment of FIG. 9, understand the scope of the present invention is not limited in this regard.

Power control in the processor can lead to enhanced power savings. For example, power can be dynamically allocate between cores, individual cores can change frequency/voltage, and multiple deep low power states can be provided to enable very low power consumption. In addition, dynamic control of the cores or independent core portions can provide for reduced power consumption by powering off components when they are not being used.

Some implementations may provide a specific power management IC (PMIC) to control platform power. Using this solution, a system may see very low (e.g., less than 5%) battery degradation over an extended duration (e.g., 16 hours) when in a given standby state, such as when in a Win8 Connected Standby state. In a Win8 idle state a battery life exceeding, e.g., 9 hours may be realized (e.g., at 150 nits). As to video playback, a long battery life can be realized, e.g., full HD video playback can occur for a minimum of 6 hours. A platform in one implementation may have an energy capacity of, e.g., 35 watt hours (Whr) for a Win8 CS using an SSD and (e.g.,) 40-44 Whr for Win8 CS using an HDD with a RST cache configuration.

A particular implementation may provide support for 15 W nominal CPU thermal design power (TDP), with a configurable CPU TDP of up to approximately 25 W TDP design point. The platform may include minimal vents owing to the thermal features described above. In addition, the platform is pillow-friendly (in that no hot air is blowing at the user). Different maximum temperature points can be realized depending on the chassis material. In one implementation of a plastic chassis (at least having to lid or base portion of plastic), the maximum operating temperature can be 52 degrees Celsius (C). And for an implementation of a metal chassis, the maximum operating temperature can be 46° C.

In different implementations, a security module such as a TPM can be integrated into a processor or can be a discrete device such as a TPM 2.0 device. With an integrated security module, also referred to as Platform Trust Technology (PTT), BIOS/firmware can be enabled to expose certain hardware features for certain security features, including secure instructions, secure boot, Intel® Anti-Theft Technology, Intel® Identity Protection Technology, Intel® Trusted Execution Technology (TXT), and Intel® Manageability Engine Technology along with secure user interfaces such as a secure keyboard and display.

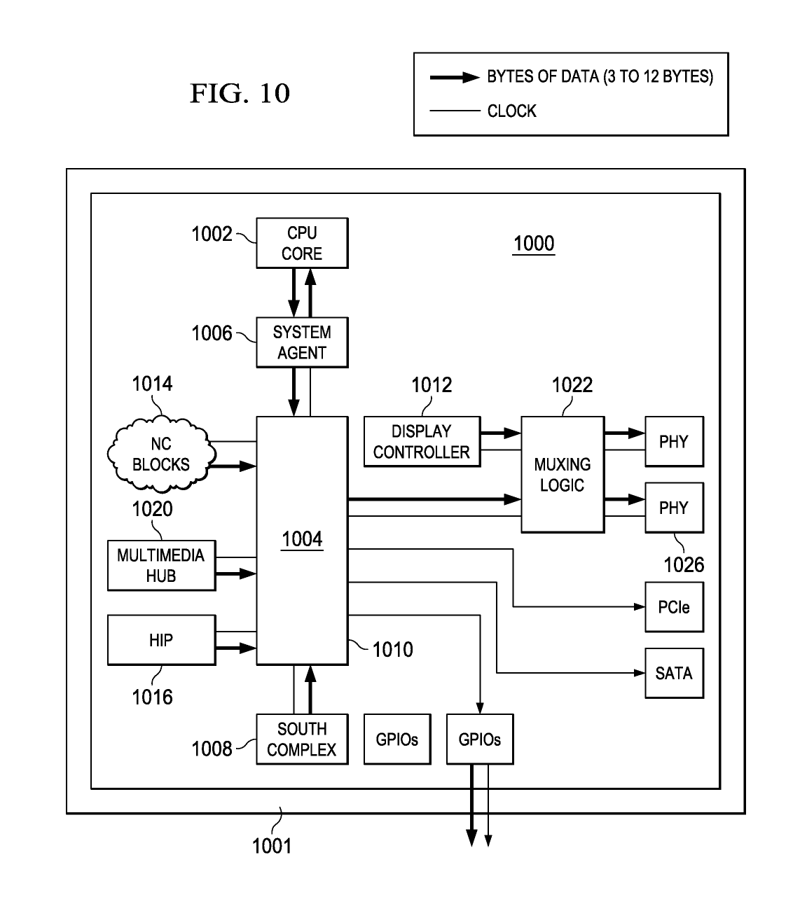

Referring to FIG. 10, an embodiment of an SOC device 1000 is illustrated. SOC 1000 includes various blocks that represent an aggregation of logical functions and/or components, including a CPU core 1002, System Agent 1006 (e.g., for an application processor), South Complex block 1008, Display Controller 1012, North Complex blocks 1014, Hard IP (HIP) block 1016, additional blocks 1018, Multimedia Hub 1020, Multiplexor (Muxing) Logic 1022, high-speed serial I/O interfaces 1026, etcetera.

In addition, SOC device 1000 includes a Peripheral Component Interface Express (PCIe) bus interface, Serial ATA bus interface, I2C interface with the enhancements described herein, and General Purpose Input/Output port(s).

It should be appreciated by one having ordinary skill in the art that a SOC device 1000 is not limited to the logical functions and components listed herein. As such, the present disclosure is amenable to include more or less logical functions and components and this may be consistent with the present disclosure so long as the SOC device 1000 is capable of interfacing with a unified sensor interconnect as described herein.

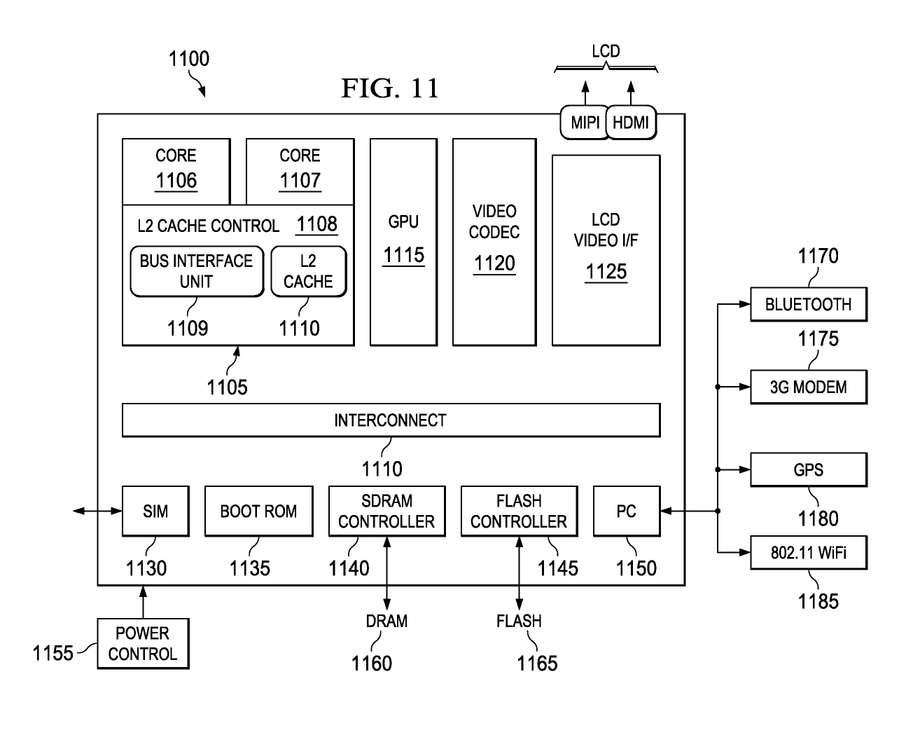

Turning next to FIG. 11, an embodiment of a system on-chip (SOC) design in accordance with the inventions is depicted. As a specific illustrative example, SOC 1100 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network.

Here, SOC 1100 includes 2 cores—1106 and 1107. Similar to the discussion above, cores 1106 and 1107 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 1106 and 1107 are coupled to cache control 1108 that is associated with bus interface unit 1109 and L2 cache 1110 to communicate with other parts of system 1100. Interconnect 1110 includes an on-chip interconnect, such as an IOSF, AMBA, or other interconnect discussed above, which potentially implements one or more aspects of the described invention.

Interconnect 1110 provides communication channels to the other components, such as a Subscriber Identity Module (SIM) 1130 to interface with a SIM card, a boot rom 1135 to hold boot code for execution by cores 1106 and 1107 to initialize and boot SOC 1100, a SDRAM controller 1140 to interface with external memory (e.g. DRAM 1160), a flash controller 1145 to interface with non-volatile memory (e.g. Flash 1165), a peripheral control Q1650 (e.g. Serial Peripheral Interface) to interface with peripherals, video codecs 1120 and Video interface 1125 to display and receive input (e.g. touch enabled input), GPU 1115 to perform graphics related computations, etc. Any of these interfaces may incorporate aspects of the invention described herein.

In addition, the system illustrates peripherals for communication, such as a Bluetooth module 1170, 3G modem 1175, GPS 1180, and WiFi 1185. Note as stated above, a UE includes a radio for communication. As a result, these peripheral communication modules are not all required. However, in a UE some form a radio for external communication is to be included.

A System on a Chip (SOC) consistent with the present disclosure includes a host; and an unified sensor interconnect to be coupled to the host and at least one device. In one embodiment, the unified sensor interconnect includes a clock line, data line, ground line, and power source line. Further, the unified sensor interconnect is to enable interrupts from at least one of the host or the at least one device.

In one implementation, the host is an application processor and the at least one device is a peripheral device external to the SOC. The at least one device may include up to 48 peripheral devices external to the SOC and coupled to the host. Furthermore, the clock line, data line, ground line, and power source line includes a clock wire, data wire, ground wire, and power source wire, respectively. In some implementations, the at least one device is to function as at least one of a master device, slave device, or both.

Additionally, when the at least one device is to function as a master device, the at least one device drives the clock line. The at least one device may include a sensor. For example, the at least one device includes at least one of a display, touchscreen, touchpad, accelerometer, gyroscope, GPS, compass, camera, or ambient light sensor. Advantageously, the unified sensor interconnect is I2C interconnect compliant.

A system consistent with the present disclosure includes a SOC which includes an aggregation of logical functions, components, at least one General Purpose Input/Output (GPIO) pin to facilitate communication between at least one legacy I2C device and a host of a computing device and an unified sensor interconnect to be coupled to the host and at least one peripheral sensor external to the SOC. In one embodiment, the unified sensor interconnect includes a clock line, data line, ground line, and power source line. Further, the unified sensor interconnect is I2C interconnect compliant. Also, the unified sensor interconnect is to enable interrupts from at least one of the host or the at least one peripheral sensor.

The at least one of the peripheral sensor includes a motion sensor, biometrics sensor, and environmental sensor. In addition, the data line is to propagate specific interrupt information and the clock line is to propagate an inbound interrupt signal. Additionally, in one implementation, a signal to be propagated over the clock line is indicative of a interrupt signal by a value of its most significant bit (MSB).

A method consistent with the present disclosure includes receiving a request on a unified sensor interconnect with a device capable of master and slave functionality; stretching the clock up to a specified time limit; processing the request during stretching the clock; and servicing the request in response to processing the request.

The method may include that device coupled to a multi-drop interconnect sends the request. In addition, the device which receives the requests functions as a slave and stretches the clock. Further, the specified time limit is approximately one millisecond. The request may be sent and received without aid from a host device.

While the present invention has been described with respect to a limited number of embodiments, those skilled in the art will appreciate numerous modifications and variations therefrom. It is intended that the appended claims cover all such modifications and variations as fall within the true spirit and scope of this present invention.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present invention.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the nontransitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. As an example, designing or setting up for operation in a particular way. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc, which are to be distinguished from the nontransitory mediums that may receive information there from.

Instructions used to program logic to perform embodiments of the invention may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magnetooptical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. A System on a Chip (SOC), comprising:
a host; and
an unified sensor interconnect to be coupled to the host and at least one device;
wherein the unified sensor interconnect includes a clock line, data line, ground line, and power source line;
wherein the unified sensor interconnect is to enable interrupts from at least one of the host or the at least one device.

2. The SOC of claim 1, wherein the host is an application processor.

3. The SOC of claim 1, wherein the at least one device is a peripheral device external to the SOC.

4. The SOC of claim 1, wherein the at least one device includes 48 peripheral devices external to the SOC and coupled to the host.

5. The SOC of claim 1, wherein the clock line, data line, ground line, and power source line includes a clock wire, data wire, ground wire, and power source wire, respectively.

6. The SOC of claim 1, wherein the at least one device is to function as at least one of a master device, slave device, or both.

7. The SOC of claim 1, wherein when the at least one device is to function as a master device, the at least one device drives the clock line.

8. The SOC of claim 1, wherein the at least one device includes a sensor.

9. The SOC of claim 1, wherein the at least one device includes at least one of a display, touchscreen, touchpad, accelerometer, gyroscope, GPS, compass, camera, or ambient light sensor.

10. The SOC of claim 1, wherein the unified sensor interconnect is I2C interconnect compliant.

11. A system, comprising:
a SOC which includes an aggregation of logical functions, components, at least one General Purpose Input/Output (GPIO) pin to facilitate communication between at least one legacy I2C device and a host of a computing device;
an unified sensor interconnect to be coupled to the host and at least one peripheral sensor external to the SOC;
wherein the unified sensor interconnect includes a clock line, data line, ground line, and power source line;
wherein the unified sensor interconnect is I2C interconnect compliant;
wherein the unified sensor interconnect is to enable interrupts from at least one of the host or the at least one peripheral sensor.

12. The system of claim 11, wherein the at least one of the peripheral sensor includes a motion sensor, biometrics sensor, and environmental sensor.

13. The system of claim 11, wherein the data line is to propagate specific interrupt information.

14. The system of claim 11, wherein the clock line is to propagate an inbound interrupt signal.

15. The system of claim 11, wherein a signal to be propagated over the clock line is indicative of a interrupt signal by a value of its most significant bit (MSB).

16. A method, comprising:
receive a request on a unified sensor interconnect with a device capable of master and slave functionality;
stretching the clock up to a specified time limit;
processing the request during stretching the clock; and
servicing the request in response to processing the request.

17. The method of claim 16, wherein a device coupled to a multi-drop interconnect sends the request.

18. The method of claim 16, wherein the device which receives the requests functions as a slave and stretches the clock.

19. The method of claim 16, wherein the specified time limit is approximately one millisecond.

20. The method of claim 16, wherein the request is sent and received without aid from a host device.
